(19) United States
(12) Patent Application Publication
(10) Pub. No.: US 2023/0383151 A1
(43) Pub. Date: Nov. 30, 2023

(54) ADHESIVE COMPOSITION FOR POLARIZING PLATE, POLARIZING PLATE, AND OPTICAL DISPLAY DEVICE

(71) Applicant: SAMSUNG SDI CO., LTD., Yongin-si, Gyeonggi-do (KR)

(72) Inventors: Tae Hyun LEE, Suwon-si (KR); Il Jin KIM, Suwon-si (KR); Mi Ran SEO, Suwon-si (KR); Mi Yeon YU, Suwon-si (KR); Woo Jin JEONG, Suwon-si (KR)

(21) Appl. No.: 18/250,732

(22) PCT Filed: Oct. 26, 2021
(86) PCT No.: PCT/KR2021/015070

§ 371 Date: Apr. 26, 2023

(30) Foreign Application Priority Data
Oct. 27, 2020 (KR) 10-2020-0140758

(51) Int. Cl. C09J 129/04; C09J 11/06; C08K 5/1515; C08K 5/17; G02B 5/30

(52) U.S. Cl. CPC C09J 129/04; C09J 11/06; C08K 5/1515; C08K 5/17; G02B 5/3016; C09J 2203/318

(57) ABSTRACT

Provided is an adhesive composition for a polarizing plate, a polarizing plate, and an optical display device, wherein the adhesive composition comprises a polyvinyl alcohol-based resin, a crosslinking agent bearing a primary amine group or a secondary amine group, and an epoxy-based compound bearing an alkylene oxide group.

### TECHNICAL FIELD

The present invention relates to an adhesive composition for polarizing plates, a polarizing plate, and an optical display device.

### BACKGROUND ART

A light emitting display device including an organic light emitting display device and the like does not require a polarizing plate. However, external light entering the light emitting display can cause deterioration in screen quality through total reflection of the external light to a panel in the light emitting display device. Therefore, the light emitting display device generally includes a polarizing plate on an upper surface of the panel. The polarizing plate may include a polarizer and a retardation film. Although the retardation film may be a polymer film, a liquid crystal film is used due to a recent trend toward thickness reduction.

Bonding between the polarizer and the liquid crystal film is generally realized by an adhesive layer interposed between the polarizer and the liquid crystal film and between two liquid crystal films, particularly in use of two sheets of liquid crystal films. However, the adhesive layer is disadvantageous in terms of flexural reliability, which is required for flexible displays. Therefore, it is suggested to use a bonding layer formed of a photocurable bonding agent instead of the adhesive layer.

However, the bonding layer formed of the photocurable bonding agent has a limitation in thickness reduction, as compared to a water-based bonding agent. On the other hand, since the liquid crystal film is a non-adhesive film exhibiting low bonding property, the water-based bonding agent does not ensure high bonding strength between the polarizer and the liquid crystal film and between the two liquid crystal films.

The background technique of the present invention is disclosed in Korean Patent Laid-open Publication No. 10-2006-0103451 and the like.

### DISCLOSURE

### Technical Problem

It is one aspect of the present invention to provide an adhesive composition for polarizing plates, which forms bonding layers exhibiting high bonding strength between a polarizer and a liquid crystal retardation layer and high bonding strength between two liquid crystal retardation layers, respectively.

It is another aspect of the present invention to provide an adhesive composition for polarizing plates, which forms bonding layers exhibiting high bonding strength between a liquid crystal retardation layer exhibiting low bonding properties and a polarizer and high bonding strength between the liquid crystal retardation layers exhibiting low bonding properties, respectively.

It is a further aspect of the present invention to provide an adhesive composition for polarizing plates, which forms a bonding layer exhibiting good high temperature/high humidity durability and good flexural reliability.

It is yet another aspect of the present invention to provide a polarizing plate and an optical display device, each of which includes the bonding layer.

### Technical Solution

One aspect of the present invention relates to an adhesive composition for polarizing plates.

1. The adhesive composition for polarizing plates includes: a polyvinyl alcohol-based resin; a crosslinking agent having a primary amine group (—NH₂) or a secondary amine group (—NH—); and an epoxy compound having an alkylene oxide group.

2. In 1, the crosslinking agent having a primary amine group or a secondary amine group may include at least one of ethylene imine-based crosslinking agent.

3. In 1 or 2, the crosslinking agent: the epoxy compound having an alkylene oxide group may be included in a weight ratio of 1:1 to 1:15.

4. In 1 to 3, the alkylene oxide group may be *—[—O—R—]—* (* being a linking site and R being a straight or branched C₂ to C₄ alkylene group).

5. In 1 to 4, the epoxy compound having an alkylene oxide group may include a compound of Chemical Formula 1:

R₁—[—O—R—]ₙ—O—R₂, [Chemical Formula 1]

(In Chemical Formula 1,
R is a linear chain or branched chain C₂ to C₄ alkylene group,
R₁ and R₂ are each independently an epoxide group or an epoxide group-containing group, and
n is an integer of 1 to 30).

6. In 1 to 5, the epoxy compound having an alkylene oxide group may include at least one of ethylene glycol diglycidyl ether; poly(ethylene glycol) diglycidyl ether; propylene glycol diglycidyl ether; and poly(propylene glycol) diglycidyl ether.

7. In 1 to 6, the composition may include: 100 parts by weight of the polyvinyl alcohol-based resin; about 0.1 parts by weight to about 50 parts by weight of the crosslinking agent having a primary amine group or a secondary amine group; and about 1 part by weight to about 100 parts by weight of the epoxy compound having an alkylene oxide group.

Another aspect of the present invention is a polarizing plate.

8. The polarizing plate includes: a polarizer; a first liquid crystal retardation layer stacked on a lower surface of the polarizer; and a first bonding layer bonding the polarizer to the first liquid crystal retardation layer, wherein the first bonding layer includes a bonding layer formed of the adhesive composition for polarizing plates according to the present invention.

9. In 8, the first liquid crystal retardation layer may include an aromatic ring-containing liquid crystal compound.

10. In 8 or 9, the polarizing plate may further include: a second bonding layer and a second liquid crystal retardation layer stacked on a lower surface of the first liquid crystal retardation layer.

11. In 8 to 10, the second liquid crystal retardation layer may include an aromatic ring-containing liquid crystal compound.

12. In 8 to 11, the second bonding layer may be formed of an adhesive composition for polarizing plates including: a polyvinyl alcohol-based resin; a crosslinking agent having a primary amine group or a secondary amine group; and an epoxy compound having an alkylene oxide group.

13. In 12, the crosslinking agent having a primary amine group or a secondary amine group may include at least one ethylene imine-based crosslinking agent.

14. In 12 or 13, the alkylene oxide group-containing epoxy compound may include at least one of ethylene glycol diglycidyl ether; poly(ethylene glycol) diglycidyl ether; propylene glycol diglycidyl ether; and poly(propylene glycol) diglycidyl ether.

A further aspect of the present invention is an optical display device.

The optical display device includes the polarizing plate according to the present invention.

### Advantageous Effects

The present invention provides an adhesive composition for polarizing plates, which forms bonding layers exhibiting high bonding strength between a polarizer and a liquid crystal retardation layer and high bonding strength between two liquid crystal retardation layers, respectively.

The present invention provides an adhesive composition for polarizing plates, which forms bonding layers exhibiting high bonding strength between a liquid crystal retardation layer exhibiting low bonding property and a polarizer and high bonding strength between the liquid crystal retardation layers exhibiting low bonding property, respectively.

The present invention provides an adhesive composition for polarizing plates, which forms a bonding layer exhibiting good high temperature/high humidity durability and good flexural reliability.

The present invention provides a polarizing plate and an optical display device, each of which includes the bonding layer.

### BRIEF DESCRIPTION OF DRAWINGS

FIG. 1 is a sectional view of a polarizing plate according to one embodiment of the present invention.

FIG. 2 is a sectional view of a polarizing plate according to another embodiment of the present invention.

FIG. 3 is a schematic plan view of a specimen in evaluation of high temperature/high humidity durability.

FIG. 4 is a sectional view of a specimen in evaluation of flexural reliability.

### BEST MODE

Hereinafter, exemplary embodiments of the present invention will be described in detail with reference to the accompanying drawings such that the present invention can be easily implemented by those skilled in the art. It should be understood that the present invention may be embodied in different ways and is not limited to the following embodiments and singular expressions include plural expressions unless the context clearly dictates otherwise.

In the drawings, components unrelated to description are omitted for clear description of the invention and like components will be denoted by like reference numerals throughout the specification. Although lengths, thicknesses or widths of various components may be exaggerated for understanding in the drawings, the present invention is not limited thereto.

Herein, spatially relative terms, such as “upper” and “lower,” are defined with reference to the accompanying drawings. Thus, it will be understood that “upper surface” can be used interchangeably with “lower surface,” and when an element is referred to as being placed “on” another element, it can be directly placed on the other element, or intervening element(s) may be present. When an element is referred to as being placed “directly on” another element, there are no intervening element(s) therebetween.

As used herein to represent a specific numerical range, “X to Y” means “greater than or equal to X and less than or equal to Y (X≤and≤Y)”.

An adhesive composition for polarizing plates according to the present invention forms a bonding layer exhibiting good bonding strength with respect to an adherend, that is, a liquid crystal retardation layer described below. The adhesive composition for polarizing plates according to the present invention forms bonding layers exhibiting high bonding strength between a polarizer and the liquid crystal retardation layer and between the liquid crystal retardation layers, respectively. In general, the liquid crystal retardation layer may be provided in the form of a liquid crystal retardation film, which includes a base film and a liquid crystal retardation layer formed on an upper surface of the base film, and may be included in a polarizing plate by removing the base film from the liquid crystal retardation layer after the liquid crystal retardation film is bonded to a polarizer of the polarizing plate. When bonding strength between the liquid crystal retardation layer and the polarizer is low, it is difficult to fabricate the polarizing plate due to separation of the liquid crystal retardation layer from the polarizer in the course of removing the base film.

In addition, the adhesive composition for polarizing plates according to the present invention forms a bonding layer exhibiting high temperature/high humidity durability and good flexural reliability. A polarizing plate according to the present invention includes a bonding layer formed of the adhesive composition for polarizing plates described above, thereby exhibiting good high temperature/high humidity durability and good flexural reliability.

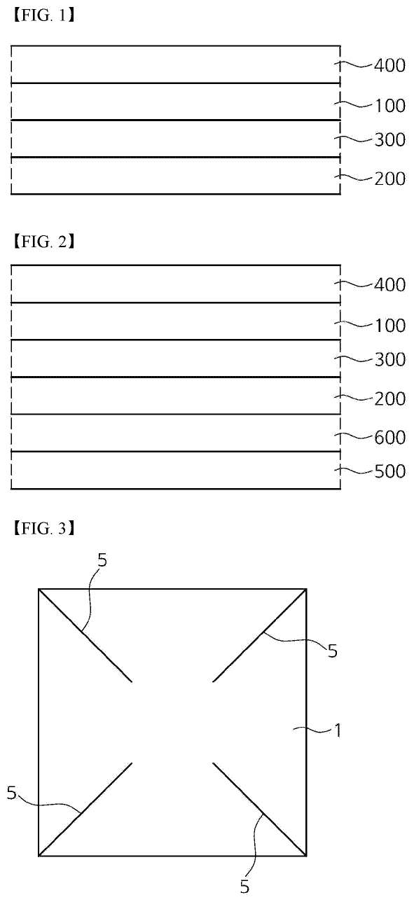

Hereinafter, a polarizing plate according to one embodiment will be described with reference to FIG. 1.

Referring to FIG. 1, the polarizing plate includes a polarizer 100, a first bonding layer 300, a first liquid crystal retardation layer 200, and a third protective layer 400. The third protective layer 400 is stacked on an upper surface of the polarizer 100, and the first bonding layer 300 and the first liquid crystal retardation layer 200 are stacked on a lower surface of the polarizer 100 in the stated order from the polarizer 100.

Polarizer

The polarizer 100 may include a typical polarizer known to those skilled in the art. For example, the polarizer may include a polarizer formed of a polyvinyl alcohol (PVA)-based resin film or a polypropylene (PP)-based resin film. For example, the polarizer may be a polyvinyl alcohol-based polarizer fabricated through adsorption of at least one of iodine and dichroic dyes to the polyvinyl alcohol-based resin film, or a polyene-based polarizer fabricated through dehydration of the polyvinyl alcohol-based resin film. The polyvinyl alcohol-based resin film may have a degree of saponification of about 85 mol % to about 100 mol %, specifically about 98 mol % to about 100 mol %. The polyvinyl alcohol-based resin film may have a degree of polymerization of about 1,000 to about 10,000, specifically about 1,500 to about 10,000. With these degrees of saponification and polymerization, the polyvinyl alcohol-based resin film may form a polarizer. The polarizer may be fabricated by a typical method known to those skilled in the art.

The polarizer 100 may have a thickness of about 5 μm to about 30 μm, specifically about 5 μm to about 25 μm. Within this range, the polarizer may be used in the polarizing plate while achieving reduction in thickness of the polarizing plate.

First Liquid Crystal Retardation Layer

The first liquid crystal retardation layer 200 may serve to improve screen quality by preventing reflection of external light through circular polarization of linearly polarized light, which is generated through linear polarization of external light by the polarizer 100 while the external light passes through the polarizer.

In one embodiment, the first liquid crystal retardation layer 200 may have an in-plane retardation (Re) of about 100 nm to about 220 nm, specifically about 100 nm to about 180 nm, for example, λ/4, at a wavelength of 550 nm. Within this range, the first liquid crystal retardation layer 200 may improve screen quality by reducing reflectance with respect to external light.

In another embodiment, the first liquid crystal retardation layer 200 may have an in-plane retardation (Re) of about 225 nm to about 350 nm, specifically about 225 nm to about 300 nm, for example, λ/2, at a wavelength of 550 nm. Within this range, the first liquid crystal retardation layer 200 may improve screen quality by reducing reflectance with respect to external light.

Herein, “in-plane retardation (Re)” may be calculated by Equation: Re=(nx−ny)×d(nx and ny indicate the indexes of refraction of a liquid crystal retardation layer in the slow axis direction and the fast axis direction, respectively, and d is the thickness of the liquid crystal retardation layer (unit: nm)).

The first liquid crystal retardation layer 200 may have a thickness of about 0.1 μm to about 30 μm, for example, about 1 μm to about 10 μm. Within this range, the polarizing plate may have a reduced thickness and may realize target retardation.

The first liquid crystal retardation layer 200 may exhibit low bonding properties. The low bonding properties of the first liquid crystal retardation layer may result from the fact that the first liquid crystal retardation layer is formed of a liquid crystal composition.

In one embodiment, the first liquid crystal retardation layer 200 may contain a hydrophobic aromatic ring-containing liquid crystal compound. The first liquid crystal retardation layer may be formed by coating a composition for liquid crystal retardation layers onto a base film, followed by curing the composition, and the aromatic ring-containing liquid crystal compound may be aligned to realize the above in-plane retardation. The aromatic ring-containing liquid crystal compound may be coated on the base film through mechanical alignment, physical alignment, or optical alignment. The base film may have one surface on which an alignment layer is not formed, or may have one surface on which the alignment layer is formed to allow easier alignment of the aromatic ring-containing liquid crystal compound. The base film may be selected from any optically transparent resin films, without being limited thereto. For example, the base film may be a cellulose-based resin film, such as a triacetylcellulose (TAC) film and the like, without being limited thereto.

In one embodiment, the aromatic ring-containing liquid crystal compound may be a polymer, an oligomer or a monomer, which includes a unit composed of an aromatic ring capable of imparting crystallinity and a polymerizable functional group. The polymerizable functional group may be a (meth)acryloyl group, an epoxy group or a vinyl ether group and may be cured by heat or light to improve strength of the first liquid crystal retardation layer.

The first liquid crystal retardation layer may be formed of a composition including the aromatic ring-containing liquid crystal compound. The composition may further include additives, such as a leveling agent, a polymerization initiator, an alignment aid, a heat stabilizer, a lubricant, a plasticizer, an antistatic agent, and the like, which are well known to those skilled in the art.

Although not shown in FIG. 1, an adhesive layer or a bonding layer may be formed on a lower surface of the first liquid crystal retardation layer 200 such that the polarizing plate may be attached to a panel of an optical display device therethrough. The adhesive layer or the bonding layer may be formed of a (meth)acrylic composition well known to those skilled in the art, without being limited thereto.

First Bonding Layer

The first bonding layer 300 may be interposed between the polarizer 100 and the first liquid crystal retardation layer 200 to bond the polarizer 100 to the first liquid crystal retardation layer 200.

In one embodiment, the first bonding layer 300 may be directly formed on each of the polarizer 100 and the first liquid crystal retardation layer 200. Herein, the expression “directly formed on” means that an adhesive layer, a bonding layer or an adhesive/bonding layer is not interposed excluding the first bonding layer 300 between the polarizer 100 and the first liquid crystal retardation layer 200.

The first bonding layer 300 may have a thickness of about 10 nm to about 500 nm, for example, about 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, or 500 nm, specifically about 50 nm to about 200 nm. Within this range, the polarizing plate may achieve thickness reduction.

The first bonding layer 300 is formed of an adhesive composition for polarizing plates described below, thereby securing good bonding strength with respect to the polarizer 100 and the first liquid crystal retardation layer 200 while providing a polarizing plate having good durability and flexural reliability under high temperature/high humidity conditions. Next, the adhesive composition for polarizing plates will be described in detail.

The adhesive composition for polarizing plates includes a polyvinyl alcohol-based resin, a crosslinking agent having a primary amine group (—NH₂) or a secondary amine group (—NH—), and an epoxy compound having an alkylene oxide group. As a result, the adhesive composition for polarizing plates realizes the effects of the bonding layer described above. In addition, the adhesive composition for polarizing plates may be a water-based adhesive composition, thus may form a thinner bonding layer than a photocurable adhesive composition.

The adhesive composition for polarizing plates may be a heat-curable composition and may form a bonding layer through heat curing of the adhesive composition.

The adhesive composition for polarizing plates may further include a water-based solvent. The water-based solvent may facilitate coating of the adhesive composition to allow formation of a thin bonding layer.

The water-based solvent may be water including ultrapure water and the like, without being limited thereto. The water-based solvent may be included in a balance amount in the adhesive composition.

The polyvinyl alcohol-based resin may be a vinyl-based polymer and may exhibit better bonding strength than other adhesive resins, if the polarizer includes the polyvinyl alcohol-based polarizer.

The polyvinyl alcohol-based resin may include a polyvinyl alcohol resin or a derivative thereof obtained through saponification of polyvinyl acetate, a resin obtained through saponification of a copolymer of vinyl acetate and a copolymerizable monomer, or a modified polyvinyl alcohol-based resin obtained through acetylation, urethanization, etherification, grafting, or phosphoric acid esterification of polyvinyl alcohol. These may be used alone or as a mixture thereof. The copolymerizable monomer may include unsaturated carboxylic acid, such as (anhydrous)maleic acid, fumaric acid, crotonic acid, itaconic acid, and (meth)acrylic acid, or esters thereof, α-olefins, such as ethylene and propylene, (meth)allyl sulfonic acid, monoalkyl maleate, disulfonic acid sodium alkyl maleate, N-methylol acrylamide, acrylamide alkyl sulfonic acid alkali salt, N-vinylpyrrolidone, N-vinylpyrrolidone derivatives, and the like.

In one embodiment, the polyvinyl alcohol-based resin may include an acetoacetyl group-containing polyvinyl alcohol-based resin. The acetoacetyl group-containing polyvinyl alcohol-based resin may assist in improvement in water resistance of the bonding layer.

In one embodiment, the polyvinyl alcohol-based resin may have an acetoacetyl group modification degree of about 1 mol % to about 30 mol %, for example, 1 mol %, 5 mol %, 10 mol %, 15 mol %, 20 mol %, 25 mol %, or 30 mol %, specifically about 1 mol % to about 10 mol %. Within this range, the polyvinyl alcohol-based resin may provide bonding strength by providing a sufficient reaction point with a crosslinking agent and may improve water resistance of the polarizing plate. The acetoacetyl group-containing polyvinyl alcohol-based resin may be prepared by any method known in the art. For example, the acetoacetyl group-containing polyvinyl alcohol-based resin may be prepared by dispersing the polyvinyl alcohol-based resin in acetic acid, followed by adding diketene, without being limited thereto.

The polyvinyl alcohol-based resin may have an average degree of polymerization of about 100 to about 3,000, for example, 100, 500, 1,000, 1,500, 2,000, 2,500, or 3,000, and an average degree of saponification of about 85 mol % to about 100 mol %, for example, 85 mol %, 86 mol %, 87 mol %, 88 mol %, 89 mol %, 90 mol %, 91 mol %, 92 mol %, 93 mol %, 94 mol %, 95 mol %, 96 mol %, 97 mol %, 98 mol %, 99 mol %, or 100 mol %, without being limited thereto. Within these ranges, bonding strength between the polarizer and the first liquid crystal retardation layer may be further improved.

The polyvinyl alcohol-based resin may be included in an amount of about 1 part by weight to about 20 parts by weight, for example, about 1, 2, 3, 4, 5, 6, 7, 8, 9, 10, 11, 12, 13, 14, 15, 16, 17, 18, 19, or 20 parts by weight, specifically about 1 part by weight to about 10 parts by weight, relative to 100 parts by weight of the water-based solvent. Within this range, the polyvinyl alcohol resin may ensure bonding strength of the bonding layer and may prevent rapid increase in viscosity of the adhesive composition to ensure good processability.

The crosslinking agent having a primary amine group (—NH₂) and/or a secondary amine group (—NH—) may provide bonding strength to the bonding layer through reaction with the polyvinyl alcohol-based resin and the epoxy compound having an alkylene oxide group described below.

The crosslinking agent may be a straight chain, branched chain or dendrimer-type crosslinking agent and may have a plurality of primary amine groups (—NH₂) or a plurality of secondary amine groups (—NH—) to provide bonding strength to the bonding layer. The crosslinking agent may be selected from among multiple crosslinking agents used in a water-based bonding agent for polarizing plates, in consideration of reaction with the epoxy compound described below, bonding strength, temperature/humidity durability, and flexural reliability.

In one embodiment, the crosslinking agent having a primary amine group (—NH₂) or a secondary amine group (—NH—) may include at least one ethylene imine-based crosslinking agent. Here, the ‘ethylene imine-based crosslinking agent’ may include a crosslinking agent obtained through at least one of ring opening, polymerization, and derivatization of ethylene imine by a method known to those skilled in the art. For example, the ethylene imine-based crosslinking agent may include a poly(ethylene imine)-based crosslinking agent.

The poly(ethylene imine)-based crosslinking agent may include a straight chain, branched chain or dendrimer-type compound having a primary amine group and/or a secondary amine group at terminals thereof, and a secondary amine group and/or a tertiary amine group in a main chain thereof. The primary amine group and/or the secondary amine group may react with a functional group of the polyvinyl alcohol-based resin, specifically, a hydroxyl group or an acetoacetyl group, to improve bonding strength.

The poly(ethylene imine)-based crosslinking agent may include a crosslinking agent having an ethylene (—CH₂CH₂—) group linked to the secondary amine group and/or the tertiary amine group and having the primary amine group and/or the secondary amine group at terminals thereof, as known in the art.

The crosslinking agent may have a weight average molecular weight of about 100 to about 1,000,000, without being limited thereto. Within this range, the crosslinking agent may secure the effects of the bonding layer according to the present invention.

The crosslinking agent may be present in an amount of about 0.1 parts by weight to about 50 parts by weight, for example, about 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight, specifically about 0.5 parts by weight to about 10 parts by weight, more specifically about 1 part by weight to about 10 parts by weight, still more specifically about 1 part by weight to about 5 parts by weight, relative to 100 parts by weight of the polyvinyl alcohol-based resin. Within this range, the crosslinking agent may secure good bonding strength of the bonding layer.

The adhesive composition may include the crosslinking agent: the epoxy compound having an alkylene oxide group in a weight ratio of about 1:1 to about 1:15, for example, about 1:1, 1:2, 1:3, 1:4, 1:5, 1:6, 1:7, 1:8, 1:9, 1:10, 1:11, 1:12, 1:13, 1:14, or 1:15, specifically about 1:1 to about 1:10, more specifically about 1:1 to about 1:5. Within this range, an epoxy group in the epoxy compound and an amine group in the crosslinking agent sufficiently react with each other to improve cohesive force in a bonding agent, thereby improving bonding strength.

On the other hand, if the first liquid crystal retardation layer is formed of the hydrophobic and aromatic ring-containing liquid crystal compound, there may be a problem of poor coatability of a water-based bonding agent. However, the epoxy compound having an alkylene oxide group may resolve this problem. In one embodiment, the epoxy compound having an alkylene oxide group may be a non-aromatic compound free from an aromatic group. In addition, the epoxy compound may react with the crosslinking agent through an epoxy group thereof and the crosslinking agent reacts with the polyvinyl alcohol-based resin, thereby providing a bonding layer having high bonding strength.

In addition, the epoxy compound having an alkylene oxide group allows the adhesive composition to be efficiently deposited to a predetermined thickness on the liquid crystal retardation layer, thereby enabling formation of a uniform bonding layer upon deposition of the adhesive composition on the liquid crystal retardation layer.

The epoxy compound having an alkylene oxide group may include a straight chain or branched chain-type compound having an alkylene oxide group repeat unit therein and epoxy groups at a side chain and/or at a terminal thereof.

The “alkylene oxide group” may be *—[—O—R—]—* (* being a linking site and R being a linear chain or branched chain C₂ to C₄ alkylene group). For example, the alkylene oxide group may be an ethylene oxide group, an n-propylene oxide group or an isopropylene oxide group. The ‘epoxy group’ may be an epoxide group or a glycidoxy group. In one embodiment, the epoxy compound having an alkylene oxide group may include a compound represented by Chemical Formula 1, without being limited thereto:

R¹—[—O—R—]ₙ—O—R² [Chemical Formula 1]

(In Chemical Formula 1,
R is a linear chain or branched chain, C₂ to C₄ alkylene group,
R¹ and R² are each independently an epoxide group or an epoxide group-containing group, and
n is an integer of 1 to 30).

The epoxide group-containing group may be a glycidyl group or a glycidoxy group.

n may be 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30.

For example, the epoxy compound having an alkylene oxide group may be one selected from among monoalkylene glycol diglycidyl ether, polyalkylene glycol diglycidyl ether and monoalkylene glycol triglycidyl ether, for example, ethylene glycol diglycidyl ether; poly(ethylene glycol) diglycidyl ether including di(ethylene glycol) diglycidyl ether, tri(ethylene glycol)diglycidyl ether, and the like; propylene glycol diglycidyl ether; and poly(propylene glycol) diglycidyl ether, without being limited thereto.

Preferably, the epoxy compound having an alkylene oxide group may include poly(ethylene glycol) diglycidyl ether and/or poly(propylene glycol) diglycidyl ether. The poly(ethylene glycol) diglycidyl ether and the poly(propylene glycol) diglycidyl ether may further improve flexural reliability even at a lower radius of curvature.

The epoxy compound having an alkylene oxide group may be included in an amount of about 1 part by weight to about 100 parts by weight, for example, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95, or 100 parts by weight, specifically about 1 part by weight to about 50 parts by weight, more specifically about 3 parts by weight to about 35 parts by weight, relative to 100 parts by weight of the polyvinyl alcohol-based resin. Within this range, the epoxy compound having an alkylene oxide group may improve bonding strength of the bonding layer.

The adhesive composition for polarizing plates may further include a typical additive in addition to the polyvinyl alcohol-based resin, the epoxy compound having an alkylene oxide group and the crosslinking agent having a primary amine group (—NH₂) or a secondary amine group (—NH—). For example, the additive may include at least one of a UV absorber, a heat stabilizer, a plasticizer, a surfactant, a reaction inhibitor, an adhesion enhancer, a thixotropic agent, a conductivity imparting agent, an antioxidant, a leveling agent, and a stabilizer, without being limited thereto.

Third Protective Layer

The third protective layer 400 may be formed on an upper surface of the polarizer 100 to protect the polarizer 100 or to provide an additional function to the polarizing plate.

The third protective layer 400 may be an optically transparent film or a protective coating layer known to those skilled in the art. For example, the protective film may include at least one resin selected from among cellulose ester-based resins including triacetylcellulose (TAC) and the like, cyclic polyolefin-based resins including amorphous cyclic polyolefin and the like, polycarbonate-based resins, polyester-based resins including polyethylene terephthalate and the like, polyether sulfone-based resins, polysulfone-based resins, polyamide-based resins, polyimide-based resins, non-cyclic polyolefin-based resins, polyacrylate-based resins including a poly(methyl methacrylate) resin and the like, polyvinyl alcohol-based resins, polyvinyl chloride-based resins, and polyvinylidene chloride-based resins.

The third protective layer 400 may have a thickness of about 5 μm to about 200 μm, specifically, about 30 μm to about 120 μm. If the third protective layer is a protective film type, the third protective layer 400 may have a thickness of about 10 m to about 100 μm, and if the third protective layer is a protective coating layer type, the third protective layer 400 may have a thickness of about 1 μm to about 50 m. Within this range, the third protective layer 400 may be used in a polarizing plate.

Although not shown in FIG. 1, functional layers, such as a hard coating layer, an anti-fingerprint layer, and an anti-reflection layer, may be further formed on an upper surface of the third protective layer 400 to provide additional functions to the polarizing plate.

In addition, although not shown in FIG. 1, the third protective layer 400 may be bonded to the polarizer 100 via a bonding layer. Here, the bonding layer may be formed of the adhesive composition according to the present invention described above, or a water-based bonding agent or a photocurable bonding agent, which is known to those skilled in the art.

Next, a polarizing plate according to another embodiment of the present invention will be described with reference to FIG. 2.

Referring to FIG. 2, the polarizing plate includes a third protective layer 400, a polarizer 100, a first bonding layer 300, a first liquid crystal retardation layer 200, a second bonding layer 600, and a second liquid crystal retardation layer 500. The third protective layer 400 is stacked on an upper surface of the polarizer 100; and the first bonding layer 300, the first liquid crystal retardation layer 200, the second bonding layer 600, and the second liquid crystal retardation layer 500 are stacked on a lower surface of the polarizer 100 in the stated order from the polarizer 100. The polarizing plate according to this embodiment is substantially the same as the polarizing plate shown in FIG. 1 except that the second bonding layer 600 and the second liquid crystal retardation layer 500 are further formed on a lower surface of the First Liquid Crystal Retardation Layer 200.

Second Liquid Crystal Retardation Layer

The second liquid crystal retardation layer 500 may serve to improve screen quality by preventing reflection of external light through circular polarization of linearly polarized light, which is generated through linear polarization of external light by the polarizer 100 while the external light passes through the polarizer.

In one embodiment, the second liquid crystal retardation layer 500 may have an in-plane retardation (Re) of about 225 nm to about 350 nm, specifically about 225 nm to about 300 nm, for example, λ/2, at a wavelength of 550 nm. Within this range, the second liquid crystal retardation layer 500 may improve screen quality by reducing reflectance with respect to external light.

In another embodiment, the second liquid crystal retardation layer 500 may have an in-plane retardation (Re) of about 100 nm to about 220 nm, specifically about 100 nm to about 180 nm, for example, λ/4, at a wavelength of 550 nm. Within this range, the second liquid crystal retardation layer 500 may improve screen quality by reducing reflectance with respect to external light.

The second liquid crystal retardation layer 500 may have a thickness of about 0.1 μm to about 30 μm, for example, about 1 μm to about 10 μm. Within this range, the polarizing plate may have a reduced thickness and may realize target retardation.

The second liquid crystal retardation layer 500 may exhibit low bonding properties. The low bonding properties of the second liquid crystal retardation layer may result from the fact that the second liquid crystal retardation layer is formed of a liquid crystal composition and has suitable ranges of nx and ny so as to realize the aforementioned in-plane retardation.

In one embodiment, the second liquid crystal retardation layer 500 may contain a hydrophobic and aromatic ring-containing liquid crystal compound. For example, the second liquid crystal retardation layer 500 may be formed of the composition described above in the first liquid crystal retardation layer 200.

Second Bonding Layer

The second bonding layer 600 may be interposed between the first liquid crystal retardation layer 200 and the second liquid crystal retardation layer 500 to bond the first liquid crystal retardation layer 200 to the second liquid crystal retardation layer 500.

In one embodiment, the second bonding layer 600 may be directly formed on each of the first liquid crystal retardation layer 200 and the second liquid crystal retardation layer 500. Herein, the expression “directly formed on” means that an adhesive layer, a bonding layer or an adhesive/bonding layer is not interposed excluding the second bonding layer 600 between the first liquid crystal retardation layer 200 and the second liquid crystal retardation layer 500.

The second bonding layer 600 may have a thickness of about 10 nm to about 500 nm, for example, about 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, or 500 nm, specifically about 50 nm to about 100 nm. Within this range, the polarizing plate may achieve thickness reduction.

In one embodiment, the second bonding layer 600 may be formed of the adhesive composition described above in the first bonding layer 300. As a result, the adhesive composition according to the present invention may realize a bonding layer having good bonding strength between a liquid crystal retardation layer having a high water contact angle and a liquid crystal retardation layer having a high water contact angle and a bonding layer having good bonding strength between liquid crystal retardation layers having low bonding properties.

In another embodiment, the second bonding layer 600 may be formed of a typical photocurable bonding agent known to those skilled in the art. The photocurable bonding agent may include an epoxy-based compound or a (meth)acrylic-based compound, and a photoinitiator. The epoxy-based compound or the (meth)acrylic-based compound, and the photoinitiator may be selected from typical kinds known to those skilled in the art.

Although not shown in FIG. 2, an adhesive layer or a bonding layer may be formed on a lower surface of the second liquid crystal retardation layer 500 such that the polarizing plate may be adhesively attached to a panel of an optical display device therethrough. The adhesive layer or the bonding layer may be formed of a (meth)acrylic composition known to those skilled in the art, without being limited thereto.

Next, a method of manufacturing a polarizing plate according to the present invention will be described.

The method of manufacturing the polarizing plate may include depositing the adhesive composition for polarizing plates according to the present invention on one surface of a liquid crystal retardation layer to form a coating layer, and attaching the coating layer to a polarizer, followed by curing the adhesive composition to bond the polarizer to the liquid crystal retardation layer.

The method of manufacturing the polarizing plate may include depositing the adhesive composition for polarizing plates according to the present invention on one surface of a liquid crystal retardation layer to form a coating layer, and attaching the coating layer to another liquid crystal retardation layer, followed by curing the adhesive composition to bond the liquid crystal retardation layer to the other liquid crystal retardation layer.

Deposition may be performed by a typical method known to those skilled in the art. For example, deposition may be performed using a die coater, a bar coater, and the like, without being limited thereto. Curing may include heat curing of the coating layer. Heat curing may be performed once or more, for example, at about 40° C. to about 100° C. for about 1 min to about 60 min, without being limited thereto.

An optical display device according to the present invention includes the polarizing plate according to the present invention.

For example, the optical display device may include a light emitting diode display including an organic light emitting diode display and the like, and a liquid crystal display, without being limited thereto. For example, the optical display device may include a flexible optical display device.

### MODE FOR INVENTION

Next, the present invention will be described in more detail with reference to some examples. It should be understood that these examples are provided for illustration only and are not to be construed in any way as limiting the invention.
A. Third protective layer: COP film (G+, Zeon Co., Ltd., a hard coating layer is formed on an upper surface thereof, thickness: 28 μm)
B. First liquid crystal retardation film: A liquid crystal retardation film (Fuji Film Co., Ltd., QLAA) including a liquid crystal retardation layer (retardation @550 nm: λ/2) on a lower surface of a base film (TAC film)
C. Second liquid crystal retardation film: A liquid crystal retardation film (Fuji Film Co., Ltd., QLAB) including a liquid crystal retardation layer (retardation @ 550 nm: λ/4) on an upper surface of a base film (TAC film)

### Example 1

<Preparation of Polarizer>

A polyvinyl alcohol-based film (Mitsubishi Chemical Co., Ltd., Polymerization degree: 2,800, Thickness: 20 μm) was dipped and dyed in a 0.3% iodine aqueous solution. The polyvinyl alcohol-based film was uniaxially stretched to 5.0 times an initial length thereof in the MD direction thereof. The stretched polyvinyl alcohol-based film was dipped for color correction in a 3% boric acid aqueous solution and a 2% potassium iodide aqueous solution. A polarizer (thickness: 7 μm) was prepared by drying the polyvinyl alcohol-based film at 50° C. for 4 min.

<Preparation of Water-Based Adhesive Composition for Polarizing Plate>

3 parts by weight of a polyvinyl alcohol-based resin was dissolved in 100 parts by weight of water at 95° C. while stirring the water for 60 min. The prepared solution was completely cooled at room temperature, and 0.1 parts by weight of a crosslinking agent and 0.1 parts by weight of an epoxy-based compound were sequentially added to the solution, followed by mixing and stirring with a magnetic stirrer, thereby preparing an adhesive composition for polarizing plates.

Table 1 shows the content of each of the crosslinking agent and the epoxy compound (unit: parts by weight) relative to 3 parts by weight of the polyvinyl alcohol-based resin. In Table 1, “−” indicates that the corresponding component is absent.

<Preparation of Photocurable Adhesive Composition for Polarizing Plates>

A photocurable adhesive composition for polarizing plates was prepared by mixing 80 parts by weight of an epoxy-based compound 2021P (3,4-epoxycyclohexylmethyl 3,4-epoxycyclohexane carboxylate, Daicel Co., Ltd.), 20 parts by weight of an epoxy-based compound EX141 (phenyl glycidyl ether, Nagase Chemtex Company), and 5 parts by weight of a cationic polymerization initiator CPI100P (SanApro Co., Ltd.).

<Preparation of Polarizing Plate>

The prepared water-based adhesive composition for polarizing plates was deposited to a predetermined thickness on each of upper and lower surfaces of the polarizer.

A lower surface of the COP film was attached to the upper surface of the polarizer, followed by drying in an oven at 50° C. for 1 min and at 85° C. for 3 min. A liquid crystal retardation side of a first liquid crystal retardation film was attached to the lower surface of the polarizer, which in turn was dried in an oven at 50° C. for 1 min and at 85° C. for 3 min, thereby preparing a laminate of the third protective layer/bonding layer/polarizer/bonding layer/liquid crystal retardation layer/TAC film.

An adhesive coating layer was formed by depositing the photocurable adhesive composition for polarizing plates on a liquid crystal retardation side of a second liquid crystal retardation film. After removal of the TAC film from the first liquid crystal retardation film, the liquid crystal retardation layer of the first liquid crystal retardation film was attached to the adhesive coating layer, which in turn was irradiated at a base film side of the second liquid crystal retardation film under a metal halide lamp at an output power of 80 W/cm and at a dose of 100 mJ/cm² and was left at room temperature for 1 day. Thereafter, the base film was removed from the second liquid crystal retardation film.

Through this process, a polarizing plate including a laminate of the third protective layer/bonding layer (formed of the water-based adhesive composition for polarizing plates, thickness: 100 nm)/polarizer/bonding layer (formed of the water-based adhesive composition for polarizing plates, thickness: 100 nm)/liquid crystal retardation layer (retardation @550 nm: λ/2)/bonding layer (formed of a photocurable adhesive composition for polarizing plates, thickness: 3 μm)/liquid crystal retardation layer (retardation @550 nm: λ/4) was formed.

### Examples 2 to 6

Polarizing plates were prepared in the same manner as in Example 1 except that the kind and/or the content of each of the components of the water-based adhesive composition for polarizing plates were changed as listed in Table 1 (unit: parts by weight).

### Example 7

A polarizing plate was prepared in the same manner as in Example 1 except that the water-based adhesive composition prepared in Example 1 was used instead of the photocurable adhesive composition. As a result, a polarizing plate including a laminate of the third protective layer/bonding layer (formed of the water-based adhesive composition for polarizing plates, thickness: 100 nm)/polarizer/bonding layer (formed of the water-based adhesive composition for polarizing plates, thickness: 100 nm)/liquid crystal retardation layer (retardation @550 nm: λ/2)/bonding layer (formed of the water-based adhesive composition for polarizing plates, thickness: 100 nm)/liquid crystal retardation layer (retardation @550 nm: λs/4) was formed.

### Comparative Examples 1 and 2

An adhesive composition for polarizing plates, a laminate, and a polarizing plate were prepared in the same manner as in Example 1 except that the kind and/or the content of each of the components of the water-based adhesive composition for polarizing plates were changed as listed in Table 1 (unit: parts by weight).

### Comparative Examples 3 and 4

Polarizing plates were prepared in the same manner as in Example 1 except that the kind and/or the content of each of the components of the water-based adhesive composition were changed as listed in Table 1 (unit: parts by weight).

Components of the bonding agents for polarizing plates used in Examples and Comparative Examples are listed in Table 1.

TABLE 1

| | A | B | C | D | E | F | G |
|---|---|---|---|---|---|---|---|
| Example 1 | 3 | 0.1 | — | — | 0.1 | — | — |
| Example 2 | 3 | 0.1 | — | — | — | 0.5 | — |
| Example 3 | 3 | 0.1 | — | — | 0.5 | — | — |
| Example 4 | 3 | 0.1 | — | — | 1 | — | — |
| Example 5 | 3 | 0.2 | — | — | 1 | — | — |
| Example 6 | 3 | 0.1 | — | — | — | — | 0.5 |
| Example 7 | 3 | 0.1 | — | — | 0.1 | — | — |
| Comparative | 3 | 0.1 | — | — | — | — | — |
| Example 1 | | | | | | | |
| Comparative | 3 | — | — | — | 0.3 | — | — |
| Example 2 | | | | | | | |
| Comparative | 3 | — | 0.75 | — | 0.3 | — | — |
| Example 3 | | | | | | | |
| Comparative | 3 | — | — | 0.5 | 0.3 | — | — |
| Example 4 | | | | | | | |

*In Table 1,
A: Polyvinyl alcohol-based resin (Mitsubishi Chemical Co., Ltd., Z200, Acetoacetyl group-modified polyvinyl alcohol, Average polymerization degree: 1200, Saponification degree: 99 mol %, Acetoacetyl group modification degree: 5 mol %)
B: Poly(ethylene imine)-based crosslinking agent (Nippon Shokubai Co., Ltd., SP018, having a primary amine group or a secondary amine group)
C: Glyoxal crosslinking agent (TCL, 40 wt % in terms of solid content, water solvent)
D: Zirconium compound (Zircosol-ZN, water solvent, Daiichi Kigenso Kagaku Kogyo Co., Ltd.)
E: Poly(ethylene glycol) Diglycidyl ether (EX821, Nagase Chemtex Company)
F: Ethylene gyycol diglycidyl ether (EX811, Nagase Chemtex Company)
G: Poly(propylene glycol) diglycidyl ether (EX 920, Nagase Chemtex Company)

The adhesive composition for polarizing plates and the polarizing plates prepared in Examples and Comparative Examples were evaluated as to the following properties and results are shown in Table 2.

(1) Transferring of liquid crystal retardation layer: A laminate of a COP film/bonding layer/polarizer/bonding layer (formed of the water-based adhesive composition for polarizing plates)/first liquid crystal retardation film (liquid crystal retardation layer/TAC film) was prepared in the same manner as in Examples and Comparative Examples. Upon removal of the TAC film from the liquid crystal retardation layer after 1 hour, a specimen having the liquid crystal retardation layer attached to the polarizer was rated as “∘” and a specimen having the liquid crystal retardation layer separated from the polarizer was rated as “X”.

(2) High temperature/high humidity durability: A specimen was prepared by cutting the polarizing plate prepared in each of Examples and Comparative Examples to a size of 50 mm×50 mm (length×width) such that an absorption axis direction of the polarizer of the polarizing plate becomes a 45° direction (diagonal direction), followed by attaching the polarizing plate to a glass plate. The prepared specimen was left in a chamber at 60° C. and 95% RH (relative humidity) for 500 hours. Referring to FIG. 3, the lengths of four decolorized portions (5) of each polarizer in the 45° direction (corners of the polarizer) with respect to the length or the width of a specimen (1) were measured and averaged. The average values were evaluated according to the following criteria.
∘: less than 1 mm
Δ: 1 mm to 3 mm
X: greater than 3 mm

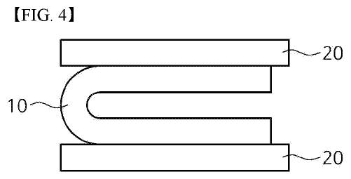

(3) Flexural reliability: A square specimen was prepared by cutting the polarizing plate prepared in each of Examples and Comparative Examples to a size of 50 mm×50 mm (length×width) such that the absorption axis direction of the polarizer became the 45° direction (diagonal direction). Referring to FIG. 4, the prepared specimen 10 was folded in half to have a radius of curvature of 3R and was placed between two stationary slits 20. Then, the specimen was left in a chamber at 60° C. and 95% RH for 500 hours. No generation of bubbles, wrinkles and wave patterns due to delamination at an interlayer interface of the folded portion was rated as “∘” and slight generation of bubbles, wrinkles and wave patterns at the interlayer interface thereof was rated as “X”.

TABLE 2

| | Transferring of | High temperature/ | |
|---|---|---|---|
| | liquid crystal | high humidity | Flexural |
| | retardation layer | durability | reliability |
| Example 1 | ◯ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Comparative | ◯ | Δ | X |
| Example 1 | | | |
| Comparative | ◯ | X | X |
| Example 2 | | | |
| Comparative | X | — | — |
| Example 3 | | | |
| Comparative | X | — | — |
| Example 4 | | | |

As shown in Table 2, the adhesive compositions according to the present invention secured good bonding strength between the polarizer and the liquid crystal retardation layer to allow efficient transfer of the liquid crystal retardation layer, and could form a bonding layer exhibiting good high temperature/humidity durability and good flexural reliability.

Conversely, the adhesive compositions of Comparative Examples failing to satisfy the features of the present invention could not achieve all of the effects of the present invention. The adhesive compositions of Comparative Examples 3 and 4 failed to form a polarizing plate due to separation of the first liquid crystal retardation layer from the polarizer in the course of removing the TAC film from the first liquid crystal retardation film.

It should be understood that various modifications, changes, alterations, and equivalent embodiments may be made by those skilled in the art without departing from the spirit and scope of the invention.

1. An adhesive composition for polarizing plates, comprising: a polyvinyl alcohol-based resin, a crosslinking agent having a primary amine group (—NH₂) or a secondary amine group (—NH—), and an epoxy-based compound having an alkylene oxide group.

2. The adhesive composition for polarizing plates as claimed in claim 1, wherein the crosslinking agent having a primary amine group or a secondary amine group comprises at least one ethylene imine-based crosslinking agent.

3. The adhesive composition for polarizing plates as claimed in claim 1, wherein the crosslinking agent: the epoxy-based compound having an alkylene oxide group are comprised in a weight ratio of about 1:1 to about 1:15.

4. The adhesive composition for polarizing plates as claimed in claim 1, wherein the alkylene oxide group is *—[—O—R—]—* (* being a linking site and R is a linear chain or branched chain C₂ to C₄ alkylene group).

5. The adhesive composition for polarizing plates as claimed in claim 1, wherein the epoxy-based compound having an alkylene oxide group comprises a compound represented by Chemical Formula 1:
R¹—[—O—R—]ₙ—O—R², [Chemical Formula 1]
where R is a linear chain or branched chain C₂ to C₄ alkylene group;
R¹ and R² are each independently an epoxide group or an epoxide group-containing group; and
n is an integer of 1 to 30.

6. The adhesive composition for polarizing plates as claimed in claim 1, wherein the epoxy-based compound having an alkylene oxide group comprises at least one of ethylene glycol diglycidyl ether; poly(ethylene glycol) diglycidyl ether; propylene glycol diglycidyl ether; and poly(propylene glycol) diglycidyl ether.

7. The adhesive composition for polarizing plates as claimed in claim 1, wherein the adhesive composition comprises:
100 parts by weight of the polyvinyl alcohol-based resin;
about 0.1 parts by weight to about 50 parts by weight of the crosslinking agent having a primary amine group or a secondary amine group; and
about 1 part by weight to about 100 parts by weight of the epoxy-based compound having an alkylene oxide group.

8. A polarizing plate comprising:
a polarizer;
a first liquid crystal retardation layer stacked on a lower surface of the polarizer; and
a first bonding layer bonding the polarizer to the first liquid crystal retardation layer,
wherein the first bonding layer comprises a bonding layer formed of the adhesive composition for polarizing plates as claimed in claim 1.

9. The polarizing plate as claimed in claim 8, wherein the first liquid crystal retardation layer comprises an aromatic ring-containing liquid crystal compound.

10. The polarizing plate as claimed in claim 8, further comprising:
a second bonding layer and a second liquid crystal retardation layer formed on a lower surface of the first liquid crystal retardation layer.

11. The polarizing plate as claimed in claim 10, wherein the second liquid crystal retardation layer comprises an aromatic ring-containing liquid crystal compound.

12. The polarizing plate as claimed in claim 10, wherein the second bonding layer is formed of an adhesive composition for polarizing plates comprising: a polyvinyl alcohol-based resin; a crosslinking agent having a primary amine group or a secondary amine group; and an epoxy-based compound having an alkylene oxide group.

13. The polarizing plate as claimed in claim 12, wherein the crosslinking agent having a primary amine group or a secondary amine group comprises at least one ethylene imine-based crosslinking agent.

14. The polarizing plate as claimed in claim 12, wherein the alkylene oxide group-containing epoxy compound comprises at least one of ethylene glycol diglycidyl ether; poly(ethylene glycol) diglycidyl ether; propylene glycol diglycidyl ether; and poly(propylene glycol) diglycidyl ether.

15. An optical display device comprising the polarizing plate as claimed in claim 8.
